(19) United States
(12) Patent Application Publication
(10) Pub. No.: US 2023/0125555 A1
(43) Pub. Date: Apr. 27, 2023

(54) Non-Access Stratum (NAS) and Core Network (CN)-Based Paging Subgrouping

(71) Applicant: Apple Inc., Cupertino, CA (US)

(72) Inventors: Vivek G. Gupta, San Jose, CA (US); Sethuraman Gurumoorthy, San Ramon, CA (US)

(21) Appl. No.: 17/972,398

(22) Filed: Oct. 24, 2022

Related U.S. Application Data
(60) Provisional application No. 63/271,669, filed on Oct. 25, 2021.

(51) Int. Cl. H04W 8/22; H04W 68/02; H04W 24/08; H04W 76/20; H04W 60/04

(52) U.S. Cl. CPC H04W 8/22; H04W 68/02; H04W 24/08; H04W 76/20; H04W 60/04

(57) ABSTRACT

Systems, methods, and apparatus for paging subgrouping are described herein. A UE may transmit a UE capability message as part of a registration procedure. The UE capability message may include paging subgroup assignment capability information. The UE capability message may be received at a CN via NAS signaling. The CN (e.g., an AMF of the CN) may assign the UE to a paging subgroup, based at least in part on the UE capability message; store the assignment in UE context; and transmit paging subgroup assignment information to both the UE and a base station. The paging subgroup assignment information may include an assignment of the UE to a paging subgroup. The UE may monitor for a paging occasion associated with the paging subgroup assigned to the UE, in a 5GMM_IDLE mode or a 5GMM_CONNECTED mode with RRC_INACTIVE indication.

### CROSS-REFERENCE TO RELATED APPLICATION(S)

This application is a nonprovisional patent application and claims the benefit under 35 U.S.C. § 119(e) of U.S. Provisional Patent Application No. 63/271,669, filed on Oct. 25, 2021, the content of which is incorporated herein by reference for all purposes.

### TECHNICAL FIELD

This application relates generally to wireless communication systems, including systems, methods, and apparatus for assigning a wireless communication device (e.g., a user equipment (UE)) to a paging subgroup.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example flow diagram for assigning a UE to a paging subgroup and subsequently paging the UE.

FIG. 2 illustrates an example exception handling for the flow diagram shown in FIG. 1.

FIG. 3 illustrates an example format for a paging probability information element.

FIG. 4 shows an example method of wireless communication by a UE, which method may be used to obtain a paging subgroup assignment and monitor a paging occasion.

FIG. 5 shows an example method of communication by a core network, which method may be used to assign a paging subgroup to a UE and page the UE.

FIG. 6 illustrates an example architecture of a wireless communication system, according to embodiments disclosed herein.

FIG. 7 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

In 3GPP 4G/LTE and 5G/NR wireless communication systems, a UE in an idle (e.g., radio resource control (RRC) IDLE) or inactive (e.g., RRC_INACTIVE) state may be paged. If a UE receives a page, the UE may transition to an active state and await further communication from a RAN or CN.

When in an idle or inactive state, a UE may periodically wake up in accord with a paging cycle and monitor a paging occasion (e.g., one or more time and frequency resources) to determine whether it has been paged. As described herein, the UE may monitor a paging occasion associated with a paging subgroup that has been assigned to the UE. A paging cycle is measured in terms of radio frames. A commonly used value for paging cycles is 128 radio frames. One radio frame is 10 milliseconds (ms). Therefore, if a paging cycle is 128 radio frames, a UE wakes up every 1.28 seconds (s) to determine whether the UE has been paged (i.e., to determine whether there is paging information for the UE).

Every time a UE wakes up to monitor a paging occasion (PO), the UE consumes relatively more power than when it is asleep (i.e., in a low power state). For a battery-operated UE, greater power consumption reduces the UE's remaining battery life. This sometimes provides a user with a less satisfactory user experience. Described herein are systems, methods, and apparatus that can reduce the power consumed by a UE and provide a more satisfactory user experience. In particular, the described systems, methods, and apparatus enable a wireless communication device (e.g., a UE) to be assigned to a paging subgroup which, in some cases, may allow the UE to wake up comparatively less frequently to monitor a paging occasion, thereby reducing the UE's power consumption.

In a 5G/NR wireless communication system, a UE may be configured with a specific UE identifier (UE_ID; e.g., a 5G serving temporary mobile subscriber identity (5G-STMSI) or a 5G inactive radio network temporary identifier (5G-RNTI)), based on whether the UE is in an RRC_IDLE or RRC_INACTIVE state, to help the UE derive a paging frame (PF) and a PO where it is expected to receive a page from the network (e.g., a RAN or CN). Since the numbers of PFs and POs are limited, it is possible that multiple UEs will monitor the same PO in expectation of a network-initiated page. Due to the many-to-one mapping nature of a UE-ID based PF and PO computation, and the limited number of actual PFs and POs, many UEs can end up monitoring the same PO.

When there is a paging message for one of the UEs monitoring the same PO, all of the UEs that are monitoring the PO will receive the paging message on a physical downlink shared channel (PDSCH). However only one of the UEs, for which the UE-ID (ue-Identity) in any of the paging records (PagingRecords) matches the UE's UE-ID, will act on the paging message. The other UEs will ignore the paging message. When a UE wakes up and receives a paging message on PDSCH, and the paging message is not intended for the UE, this is referred to as a “false page.”

When multiple UEs monitor the same PO, a UE may unnecessarily receive and decode PDSCH associated with a different UE's page, which increases the UE's power consumption. Power consumption for processing (e.g., decoding) both physical downlink control channel (PDCCH; the physical channel that carries downlink control information (DCI)) and PDSCH (the data bearing channel) in layer 1 (L1) is, according to some estimates, about 2.4 times the power consumption of processing PDCCH alone.

When the network initiates a page to a UE, and in the absence of clear cell level information on where the UE is located, a network may initially page a UE within a given tracking area (TA)/RAN notification area. If the network does not receive a response from the UE, the network may progressively increase the scope of paging by repeating the UE's page in a larger geographical area. If the network does not receive a response from the UE, the network may iteratively increase its paging area scope to include additional geographical areas. This further increases the likelihood that other UEs (e.g., non-intended IDLE/INACTIVE UEs) will receive false pages.

To reduce the paging false alarm probability, a network could more accurately record the current location of the IDLE/INACTIVE UE that it wishes to page, such that the network could reduce the paging geography scope and mitigate the need to increase the paging geography scope due to unsuccessful pages. Additionally, or alternatively, a network could map a smaller number of UEs to a PO, with the intent of reducing the number of UEs that are unintentionally woken up when the network is trying to deliver a page to a particular UE. However, improved UE tracking solutions are currently not available, and reducing the number of UEs mapped to a PO may introduce other issues.

One way to reduce the number of false pages experienced by a UE is to divide the UEs that share a PO into different paging subgroups. UEs may be divided into paging subgroups in various ways, and in some cases may be divided into paging subgroups based on UE type, power profile, other UE information, or information known by the network (e.g., a RAN or CN). In some cases, UEs that are expected to receive relatively fewer pages and/or are limited by power constraints can be grouped together in a first paging subgroup, while UEs that are expected to receive relatively more pages and/or are less limited by power constraints can be grouped together in a second paging subgroup. A UE may then be notified, prior to its PO, and as part of an paging early indication (PEI), whether the PO contains paging information for its paging subgroup. If the PO does not contain such paging information, the UE need not wake up and decode PDSCH during the PO.

A UE may be notified of whether a PO contains paging information for its paging subgroup in different ways. For example, a UE may be notified using a downlink control information (DCI)-based notification or a PEI-based notification. For a DCI-based notification, a paging indication for a paging subgroup may be provided using paging DCI. For example, the network may indicate whether a paging subgroup (or whether each paging subgroup) needs to monitor a corresponding PO (or paging PDSCH). In some cases, spare bits in paging DCI may be used for this purpose. For example, there are six bits reserved in the DCI format 1_0 with paging RNTI (P-RNTI; see, e.g., section 7.3.1.2.1 of 3GPP technical specification (TS) 23.212), and there are 5 bits reserved in the Short Message for paging (see section 6.5 in 3GPP TS 38.331). These bits could potentially be used to defined “paging groups”, and a UE may be assigned to a paging group during registration/attach. When the UE is paged, the CN may include the paging group of the UE in its paging message, and the RAN may transfer the paging group in the paging DCI. Alternatively, a new DCI format may be defined.

For a PEI-based notification, a paging indication for a paging subgroup may be provided using a paging early indication or wake-up signal (WUS) for paging subgroups. For example, the network may transmit an early indication or wake-up signal before a PO. The indication or WUS may apply to a particular paging subgroup. A UE that does not receive an indication of WUS referencing its paging subgroup need not monitor its corresponding PO.

Different paging subgrouping approaches are possible. For example, paging subgrouping may be a CN-assigned paging subgrouping and/or a UEID-based paging subgrouping. Further, the CN-assigned paging subgrouping and/or the UEID-based paging subgrouping may be on a per cell basis. CN-assigned paging subgrouping may use a CN's access and mobility management function (AMF) to assign a paging subgroup ID to a UE. The AMF may indicate the paging subgroup ID to the UE, which by way of a non-limiting example, may be on a per cell basis using NAS signaling, and may also store the paging subgroup ID in UE context at the CN. The AMF may also convey the subgroup information to a base station for paging the UE when it is in an RRC_IDLE or RRC_INACTIVE state. The base station may inform other base stations in its RAN about a UE's paging subgroup ID for RAN paging. UEID-based paging subgrouping (based on a legacy UE-ID approach) may require, in addition to the already available information for legacy UEID-based grouping in a PO, the total number of UEID-based paging subgroups (Nsg) that are supported by the network. The number Nsg may be determined by a RAN and broadcast in system information. In some cases, Nsg may be controlled on a cell basis and can be different in different cells.

For co-existence of CN-assigned and UEID-based paging subgrouping approaches, all cells in a registration area may support the same number of CN-assigned paging subgroups and UEID-based paging subgroups, so that there is no re-mapping between the two. A RAN may broadcast separate capabilities for CN-assigned paging subgrouping and UEID-based paging subgrouping.

Both the network and individual UEs may indicate their support of CN-assigned paging subgrouping and UEID-based paging subgrouping. UEID-based paging subgrouping may be used as a fallback if CN-assigned paging subgrouping is not supported (that is, assuming that UEID-based paging subgrouping is supported).

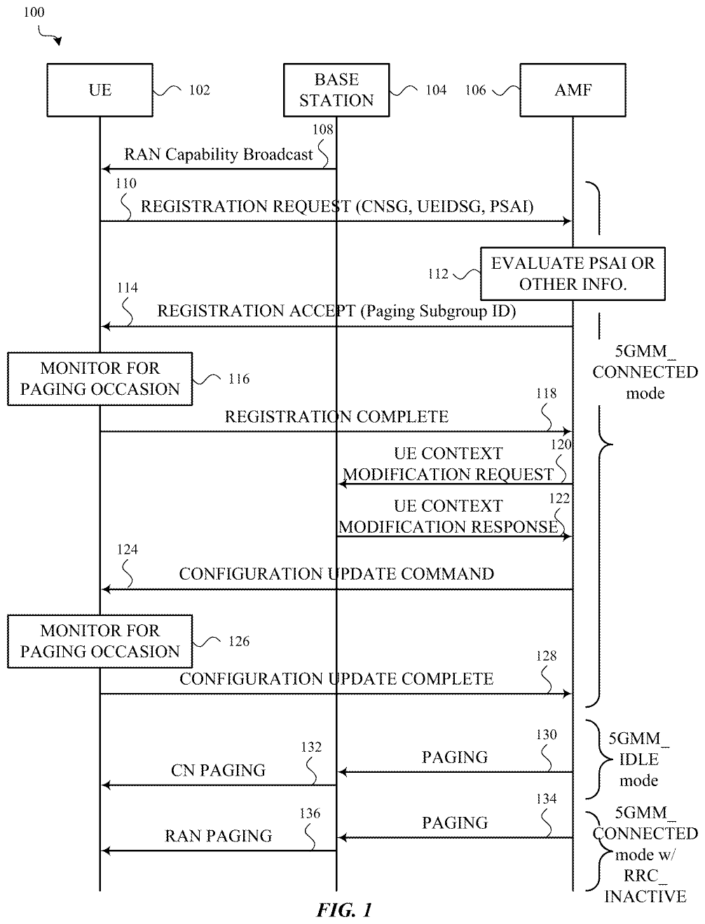

FIG. 1 illustrates an example flow diagram 100 for assigning a UE 102 to a paging subgroup and subsequently paging the UE 102. The messages shown in FIG. 1 are transmitted or received by a UE 102, a base station 104 (e.g., a gNB), and a CN (e.g., an AMF 106 of a CN).

At 108, a base station 104 may optionally transmit (e.g., broadcast) a RAN capability message. The RAN capability message may indicate the base station's (or RAN's) support for paging subgroup assignments. In some cases, the RAN capability message may indicate the base station's (or RAN's) support for CN-assigned paging subgrouping (CNSG) and/or UEID-based paging subgrouping (UEIDSG). If CN-assigned or UEID-based paging subgrouping is supported, the RAN capability message may also indicate a total number of paging subgroups (Nsg) that are supported. The RAN capability message may also indicate other RAN capabilities.

At 110, the UE 102 may transmit a UE capability message. In some cases, the UE capability message may be transmitted in response to receiving the RAN capability message. In other cases, the UE capability message may be transmitted independently of whether or when the UE 102 receives the RAN capability message. The UE capability message may be transmitted as a NAS message to the CN (e.g., to the AMF 106), and may be transmitted to the CN via the base station 104. In some embodiments, the UE capability message may be transmitted with (e.g., as part of) a registration request (REGISTRATION REQUEST) message. The registration request message may be transmitted during an initial registration of the UE 102 to the CN (e.g., to the AMF 106 of the CN), or during a mobility and periodic registration update (MRU). An MRU may be performed, for example, during a transition between 4G/LTE and 5G/NR services, when the UE 102 enters a new tracking area (TA), when the UE 102 has a change in UE assistance information (including a change in PSAI), when there is a change in network configuration or number of paging subgroups (Nsg), and so on.

The UE capability message may include paging subgroup assignment capability information, such as an indication of support for paging subgrouping assistance information (PSAI), an indication of support for CN-assigned paging subgrouping (CNSG) allocated by an AMF, and/or an indication of support for UEID-based paging subgrouping (UEIDSG) based on a temporary identifier for the UE 102 within an NG-RAN. The UE capability message may be sent when there is no ongoing emergency protocol data unit (PDU) session.

In some embodiments, the UE 102 may transmit PSAI with the UE capability message. The PSAI may include, for example, paging probability information and/or a power profile of the UE 102. The paging probability information may in some cases identify a paging probability group within a set of predefined paging probability groups. The paging probability group may, in turn, identify a group of UEs having a paging probability that is similar to a paging probability of the UE 102. The power profile may include at least one of: a type of the UE 102, an expected battery duration of the UE 102, or an available power budget of the UE 102.

At 112, the CN (e.g., the AMF 106) may evaluate the UE's capabilities and support for paging subgrouping. The CN (e.g., the AMF 106) may also evaluate the UE's PSAI and/or information regarding the UE, the CN, other UEs, or the RAN. When useful (e.g., based on network support or preference), the CN (e.g., the AMF 106) may assign the UE 102 to a paging subgroup (e.g., to a CN-assigned paging subgroup); assign the UE 102 a paging subgroup identifier (ID); and store the paging subgroup ID in UE context. Other UEs may also be assigned to the paging subgroup.

At 114, the CN (e.g., the AMF 106) may transmit paging subgroup assignment information to the UE 102. By way of a non-limiting example, in some embodiments, the paging subgroup assignment information may be on a per cell basis. The paging subgroup assignment information may be transmitted in a NAS message to the UE 102, and may be transmitted to the UE 102 via the base station 104. In some embodiments, the paging subgroup assignment information may be transmitted with (e.g., as part of) a registration accept (REGISTRATION ACCEPT) message. The paging subgroup assignment information may include, for example, an assignment of the UE 102 to a paging subgroup. In some cases, the assignment may be indicated by the paging subgroup ID determined at 112. The paging subgroup assignment information may be based at least in part on the UE capability message transmitted by the UE 102 but, in some cases, may only be based on the fact the UE 102 sent the UE capability message and/or indicated a support for CNSG. The paging subgroup assignment information may or may not be based on any PSAI transmitted by the UE 102.

At 116, the UE 102 may begin monitoring a paging subgroup assigned to the UE 102 for a paging occasion when in an RRC_IDLE or RRC_INACTIVE state. Monitoring for a paging occasion associated with the paging subgroup assigned to the UE 102, in some embodiments, may be based at least in part on the paging subgroup assignment information (e.g., the paging subgroup assignment information for a particular cell), as received at 114. At 118, the UE 102 may optionally acknowledge receipt of the paging subgroup assignment information. The acknowledgement may be transmitted as a NAS message to the CN (e.g., to the AMF 106), and may be transmitted to the CN via the base station 104. In some embodiments, the acknowledgement may be transmitted with (or as) a registration complete (REGISTRATION COMPLETE) message.

Having configured the UE 102 to monitor for a paging occasion based on paging subgroup assignment information, the CN (e.g., the AMF 106) can inform the base station 104 of the UE's assignment to a CN-assigned paging subgroup. For example, at 120, the CN (e.g., the AMF 106) may transmit the paging subgroup assignment information for the UE to the base station 104. In some embodiments, the paging subgroup assignment information may be transmitted with a UE context modification request (UE CONTEXT MODIFICATION REQUEST) message. The paging subgroup assignment information may include, for example, an assignment of the UE 102 to a paging subgroup. In some cases, the assignment may be indicated by the paging subgroup ID determined at 112.

At 122, the base station 104 may optionally acknowledge receipt of the paging subgroup assignment information. In some embodiments, the acknowledgement may be transmitted to the CN (e.g., to the AMF 106) with (or as) a UE context modification response (UE CONTEXT MODIFICATION RESPONSE) message.

Although the messaging between the CN (e.g., the AMF 106) and the base station 104, at 120 and 122, is shown to occur after the messaging between the CN (e.g., the AMF 106) and the UE 102, at 114 and 118, the messaging between the CN and the base station 104 may alternatively be performed before or interspersed with the messaging between the CN and the UE 102.

At 124, the CN (e.g., the AMF 106) may optionally reconfigure the UE's paging subgroup and transmit updated paging subgroup assignment information to the UE 102. The updated paging subgroup assignment information may be transmitted in a NAS message to the UE 102, and may be transmitted to the UE 102 via the base station 104. In some embodiments, the updated paging subgroup assignment information may be transmitted with a configuration update (CONFIGURATION UPDATE COMMAND) message. The updated paging subgroup assignment information may include, for example, an assignment of the UE 102 to a new paging subgroup. In some cases, the assignment may be indicated by a new paging subgroup ID determined by the CN (e.g., by the AMF 106). The paging subgroup assignment information may or may not be based on any PSAI transmitted by the UE 102 (e.g., at 110).

At 126, the UE 102 may begin monitoring for a paging occasion associated with the paging subgroup assigned to the UE 102 when in an RRC_IDLE or RRC_INACTIVE state. Monitoring for a paging occasion associated with the paging subgroup assigned to the UE 102, in some embodiments, may be based at least in part on the paging subgroup assignment information (e.g., the paging subgroup assignment information for a particular cell), as received at 124. At 128, the UE 102 may optionally acknowledge receipt of the updated paging subgroup assignment information. The acknowledgement may be transmitted as a NAS message to the CN (e.g., to the AMF 106), and may be transmitted to the CN via the base station 104. In some embodiments, the acknowledgement may be transmitted with (or as) a configuration update complete (CONFIGURATION UPDATE COMPLETE) message.

At operations 110-128, the UE 102 may be in a 5G mobility management (5GMM)_CONNECTED mode.

When the UE 102 is in a 5GMM_IDLE mode, the CN (via the AMF 106) may page the UE 102 by transmitting paging (PAGING) information to the base station 104 at 130. The paging information may include the paging subgroup ID for the UE's paging subgroup. The base station 104 may then perform CN paging for the UE 102 at 132.

When the UE 102 is in a 5GMM_CONNECTED mode with RRC_INACTIVE indication, the CN (via the AMF 106) may page the UE 102 by transmitting paging (PAGING) information to the base station 104 at 134. The paging information may include the paging subgroup ID for the UE's paging subgroup. The base station 104 may then perform RAN paging for the UE 102 at 136.

When in the 5GMM_IDLE mode or 5GMM_CONNECTED mode with RRC_INACTIVE indication, a monitored paging occasion may occur comparatively less frequently for the UE 102, as a member of the paging subgroup, than a second paging occasion occurs for a second UE with no paging subgroup assignment.

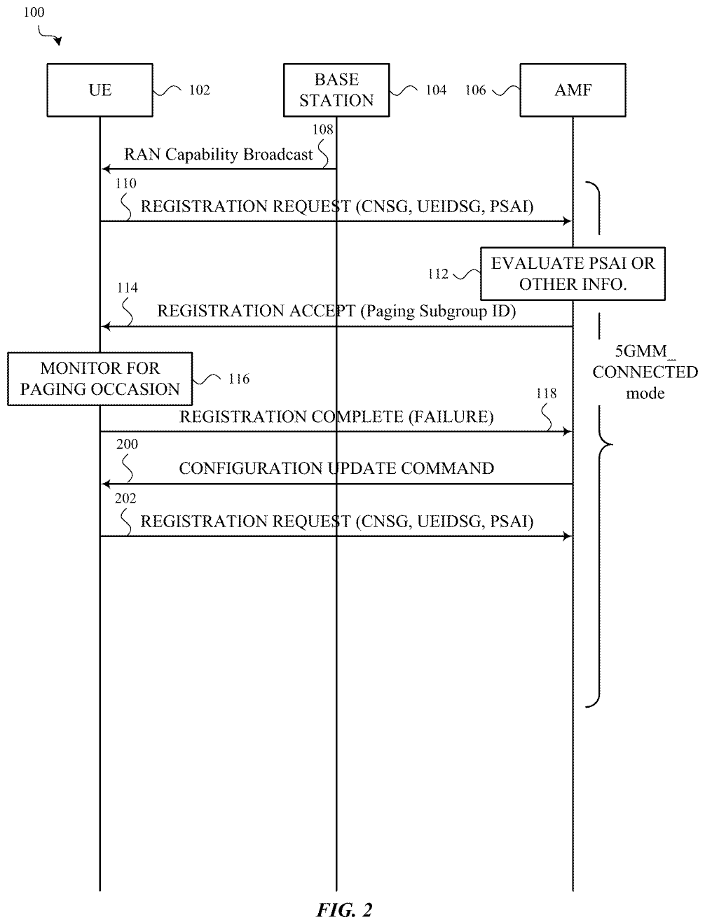

FIG. 2 illustrates an example exception handling for the flow diagram 100 shown in FIG. 1. As shown in FIG. 2, it is possible that the UE 102 may not receive the paging subgroup assignment information transmitted by the CN (e.g., the AMF 106) at 114; or the UE 102 may not send an acknowledgement of receiving the paging subgroup assignment information at 118; or the CN (e.g., the AMF 106) may not receive the UE's acknowledgement of receiving the paging subgroup assignment information at 118. All of these conditions are generally referred to as a failure in the acknowledgement (e.g., a failure in the REGISTRATION COMPLETE message) and can cause the CN to not know which paging subgroup ID, if any, is currently being used by the UE 102. For example, depending on a UE's prior configuration, a UE that does not acknowledge receipt of a CN-assigned paging subgroup ID could be using an old CN-assigned paging subgroup ID, a current CN-assigned paging subgroup ID, a UEID-based paging subgroup ID, or no paging subgroup ID.

After determining that the acknowledgement at 118 is not received, or after expiration of a timeout period, the CN (e.g., the AMF 106) may transmit a configuration update (CONFIGURATION UPDATE COMMAND) message to the UE 102 at 200. The configuration update message may indicate to the UE 102 that the UE's current configuration of paging subgroup ID is invalid. In some cases, the configuration update message may include new paging subgroup assignment information (e.g., a new paging subgroup ID). In these cases, the CN (e.g., the 106) may expect the UE 102 to acknowledge the new paging subgroup assignment information in a configuration update complete (CONFIGURATION UPDATE COMPLETE) message. In other cases, the configuration update message may not include a new paging subgroup ID, and may request the UE 102 to initiate a registration procedure (e.g., as described with reference to 110, 114, and 118 with reference to FIG. 1) or otherwise obtain a new paging subgroup ID as soon as possible. The UE 102 may then transmit another UE capability message with another registration request (REGISTRATION REQUEST) message at 202.

The paging subgroup assignment capability information transmitted as part of the UE capability message described with reference to FIGS. 1 and 2 may in some cases be transmitted in an information element (IE), such as in the 5GMM capability IE described in 3GPP TS 24.501, section 9.11.3.1. In some cases, one or more new fields may be added to the 5GMM capability IE, such as a first field for the indication of support for PSAI, a second field for the indication of support for CNSG allocated by an AMF, and/or a third field for the indication of support for UEIDSG based on a temporary identifier for a UE within an NG-RAN. In some cases, a field may not be provided for the indication of support for UEIDSG, and support for UEIDSG may be assumed if no other paging subgroup assignment capability information is provided by a UE.

The PSAI that the UE may optionally transmit with the UE capability message may in some cases be transmitted in one or more new PSAI IEs, which may be added to the IEs described in 3GPP TS 24.501. The PSAI may in some cases include a paging probability of the UE. In one example, the paging probability of a UE may be indicated as 5%, 10%, 15%, and so on. In another example, the paging probability may be indicated as a particular increment of 5 units, between 0 and 100. For example, the paging probably may be indicated as being within a range of 0-5, 5-10, 10-15, and so on). Two UEs that are assigned the same paging probability can be considered to more or less equally disturb each other.

PSAI may also indicate a UE's power profile. In some embodiments, a UE's power profile may be defined by a device type (e.g., phone, Internet of Things (IoT) sensor, machine-type communication (MTC) device, and so on). While a phone may have a battery that is designed to last several hours or a day before needing a charge, an IoT device may have a battery that is designed to last several months or years before needing a charge. Phones may also receive more frequent pages, while an IoT device may receive infrequent pages. A UE's power profile may alternatively or additionally be defined by an expected battery duration, such as a duration of hours, days, months, or years. Various ranges may also be defined, similarly to (or differently from) how ranges are defined for different paging probabilities. A UE's power profile may alternatively or additionally be defined by the UE's currently available power budget (i.e., the remaining charge on the UE's battery). A currently available power budget may be defined as low, medium, or high, in some examples. Alternatively, and as another example, a currently available power budget may be defined as a remaining charge percentage.

PSAI may also indicate a UE's mobility. A UE's mobility may be indicated, for example, as high or low (or high, medium, or low). Often, a more mobile UE will consume more power and need to preserve its battery life.

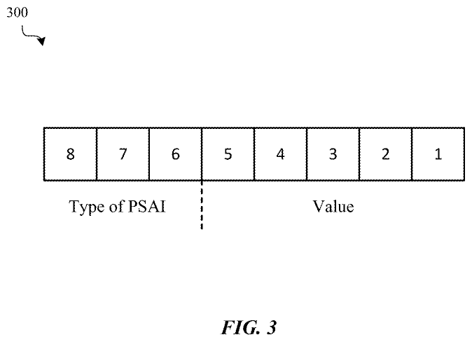

FIG. 3 shows an example format for an IE 300 used to indicate PSAI. The IE 300 includes a set of bits (e.g., eight bits). A set of most significant bits (MSBs) may indicate a type of PSAI, and a set of least significant bits (LSBs) may indicate a value. For example, the type of PSAI may be 000 for “paging probability,” and the value 00000 may indicate a probability of 0-5%, a value of 00001 may indicate a probability of 5-10%, a value of 00010 may indicate a probability of 10-15%, and so on. Alternatively, the type of PSAI may be 001 for “power profile,” and the value 00000 may indicate a phone, a value of 00001 may indicate an IoT sensor, and so on. Alternatively, different IEs or fields may be allocated for different types of PSAI.

The paging subgroup assignment information (e.g., the paging subgroup ID) transmitted by the CN (e.g., the AMF) may in some cases be transmitted in a new IE, which new IE may be added to the IEs described in 3GPP TS 24.501. For example, a paging subgroup ID IE may be added to 3GPP TS 24.501. The indicated paging subgroup ID may be a CN-assigned paging subgroup.

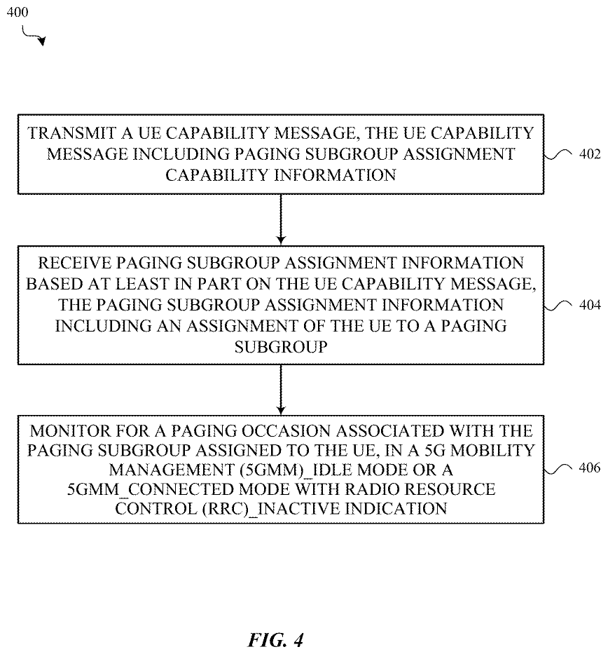

FIG. 4 shows an example method 400 of wireless communication by a UE, which method 400 may be used to obtain a paging subgroup assignment and monitor a paging occasion.

At block 402, the method 400 may include transmitting a UE capability message. The UE capability message may include paging subgroup assignment capability information, such as any of the paging subgroup assignment capability information described with reference to FIGS. 1-3. Optionally, the UE may transmit PSAI with the UE capability message.

At block 404, the method 400 may include receiving paging subgroup assignment information based at least in part on the UE capability message. The paging subgroup assignment information may include an assignment of the UE to a paging subgroup, which in some embodiments, may be on a per cell basis, and in some cases may include a CN-assigned paging subgroup ID.

At block 406, the method 400 may include monitoring for a paging occasion associated with a paging subgroup assigned to the UE, in a 5GMM_IDLE mode or a 5GMM_CONNECTED mode with RRC_INACTIVE indication. Monitoring of the paging occasion associated with the paging subgroup assigned to the UE, in some embodiments, may be based at least in part on the paging subgroup assignment information (e.g., the paging subgroup assignment information for a particular cell), as received at 404.

In some embodiments of the method 400, the UE capability message may be transmitted with (e.g., as part of) a registration request (REGISTRATION REQUEST) message. In some embodiments, the paging subgroup assignment information may be received with (e.g., as part of) a registration accept (REGISTRATION ACCEPT) message.

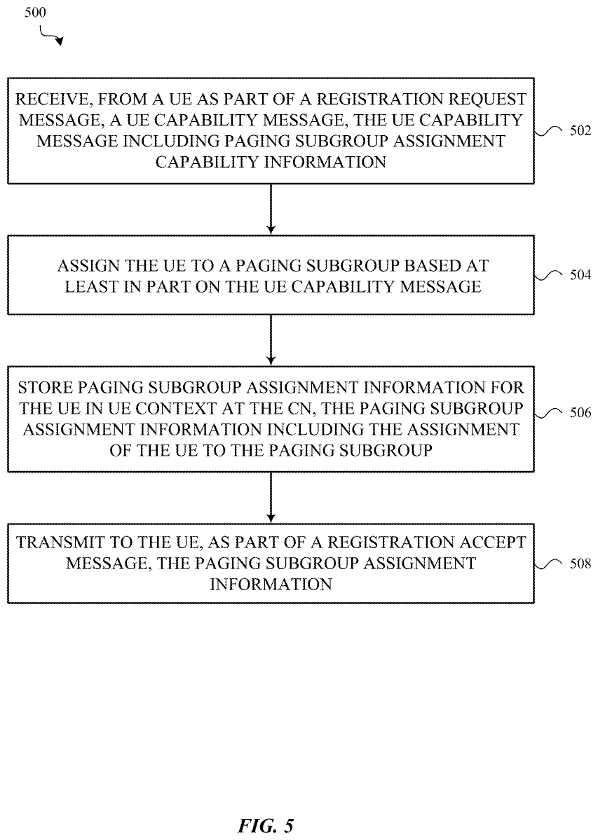

FIG. 5 shows an example method 500 of communication by a CN (e.g., by an AMF of a CN), which method 500 may be used to assign a paging subgroup to a UE and page the UE.

At block 502, the method 500 may include receiving, from a UE as part of a registration request (REGISTRATION REQUEST) message, a UE capability message. The UE capability message may include paging subgroup assignment capability information, such as any of the paging subgroup assignment capability information described with reference to FIGS. 1-3. Optionally, the CN (e.g., the AMF) may receive PSAI with the UE capability message.

At block 504, the method 500 may include assigning the UE to a paging subgroup based at least in part on the UE capability message.

At block 506, the method 500 may include storing paging subgroup assignment information for the UE in UE context at the CN. The paging subgroup assignment information may include the assignment of the UE to the paging subgroup, and in some cases may include a CN-assigned paging subgroup ID.

At block 508, the method 500 may include transmitting to the UE, as part of a registration accept (REGISTRATION ACCEPT) message, the paging subgroup assignment information.

In some embodiments, the method 500 may also include transmitting, to a base station in communication with the UE, a UE context modification request (UE CONTEXT MODIFICATION REQUEST) message including the assignment of the UE to the paging subgroup. By way of a non-limiting example, the UE context modification request message may be transmitted on a per cell basis.

In some cases, the method 500 may include determining the UE has not acknowledged receipt of the paging subgroup assignment information. In these embodiments, the method 500 may include transmitting to the UE, in response to determining the UE has not acknowledged receipt of the paging subgroup assignment information, new paging subgroup assignment information. Additionally of alternatively, the method 500 may include transmitting to the UE, in response to determining the UE has not acknowledged receipt of the paging subgroup assignment information, a request for the UE to initiate a registration procedure.

Embodiments contemplated herein include an apparatus having means to perform one or more elements of the method 400 or 500. In the context of method 400, this apparatus may be, for example, an apparatus of a UE (such as a wireless device 102, 602, 702 that is a UE, as described herein). In the context of method 500, this apparatus may be, for example, an apparatus of a CN (such as a network device 106, 626, 724 of a CN (e.g., an AMF), as described herein).

Embodiments contemplated herein include one or more non-transitory computer-readable media storing instructions to cause an electronic device, upon execution of the instructions by one or more processors of the electronic device, to perform one or more elements of the method 400 or 500. In the context of method 400, this non-transitory computer-readable media may be, for example, a memory of a UE (such as a memory 706 of a wireless device 702 that is a UE, as described herein). In the context of method 500, this non-transitory computer-readable media may be, for example, a memory of a CN (such as a memory 728 of a network device 724 of a CN (e.g., an AMF), as described herein).

Embodiments contemplated herein include an apparatus having logic, modules, or circuitry to perform one or more elements of the method 400 or 500. In the context of method 400, this apparatus may be, for example, an apparatus of a UE (such as a wireless device 702 that is a UE, as described herein). In the context of method 500, this apparatus may be, for example, an apparatus of a CN (such as a network device 724 of a CN (e.g., an AMF), as described herein).

Embodiments contemplated herein include an apparatus having one or more processors and one or more computer-readable media, using or storing instructions that, when executed by the one or more processors, cause the one or more processors to perform one or more elements of the method 400 or 500. In the context of method 400, this apparatus may be, for example, an apparatus of a UE (such as a wireless device 702 that is a UE, as described herein). In the context of the method 500, this apparatus may be, for example, an apparatus of a CN (such as a network device 724 of a CN (e.g., an AMF), as described herein).

Embodiments contemplated herein include a signal as described in or related to one or more elements of the method 400 or 500.

Embodiments contemplated herein include a computer program or computer program product having instructions, wherein execution of the program by a processor causes the processor to carry out one or more elements of the method 400 or 500. In the context of method 400, the processor may be a processor of a UE (such as a processor(s) 704 of a wireless device 702 that is a UE, as described herein), and the instructions may be, for example, located in the processor and/or on a memory of the UE (such as a memory 706 of a wireless device 702 that is a UE, as described herein). In the context of method 500, the processor may be a processor of a CN (such as a processor(s) 726 of a network device 724 of a CN (e.g., an AMF), as described herein), and the instructions may be, for example, located in the processor and/or on a memory of the CN (such as a memory 728 of a network device 724 of a CN (e.g., an AMF), as described herein).

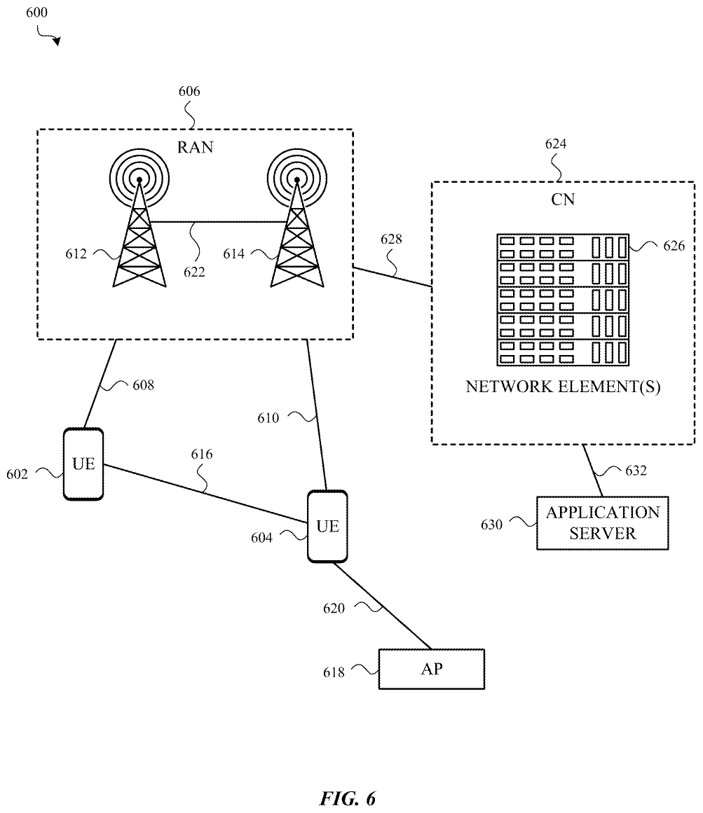

FIG. 6 illustrates an example architecture of a wireless communication system 600, according to embodiments disclosed herein. The following description is provided for an example wireless communication system 600 that operates in conjunction with the 4G or LTE system standards and/or 5G or NR system standards as provided by 3GPP technical specifications.

As shown by FIG. 6, the wireless communication system 600 includes UE 602 and UE 604 (although any number of UEs may be used). In this example, the UE 602 and the UE 604 are illustrated as smartphones (e.g., handheld touchscreen mobile computing devices connectable to one or more cellular networks), but may also comprise any mobile or non-mobile computing device configured for wireless communication.

The UE 602 and UE 604 may be configured to communicatively couple with a RAN 606. In embodiments, the RAN 606 may be NG-RAN, E-UTRAN, etc. The UE 602 and UE 604 utilize connections (or channels) (shown as connection 608 and connection 610, respectively) with the RAN 606, each of which comprises a physical communications interface. The RAN 606 can include one or more base stations, such as base station 612 and base station 614, that enable the connection 608 and connection 610.

In this example, the connection 608 and connection 610 are air interfaces to enable such communicative coupling, and may be consistent with RAT(s) used by the RAN 606, such as, for example, an LTE and/or NR.

In some embodiments, the UE 602 and UE 604 may also directly exchange communication data via a sidelink interface 616. The UE 604 is shown to be configured to access an access point (shown as AP 618) via connection 620. By way of example, the connection 620 can comprise a local wireless connection, such as a connection consistent with any IEEE 802.11 protocol, wherein the AP 618 may comprise a Wi-Fi® router. In this example, the AP 618 may be connected to another network (for example, the Internet) without going through a CN 624.

In embodiments, the UE 602 and UE 604 can be configured to communicate using orthogonal frequency division multiplexing (OFDM) communication signals with each other or with the base station 612 and/or the base station 614 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 612 or base station 614 may be implemented as one or more software entities running on server computers as part of a virtual network. In addition, or in other embodiments, the base station 612 or base station 614 may be configured to communicate with one another via interface 622. In embodiments where the wireless communication system 600 is an LTE system (e.g., when the CN 624 is an EPC), the interface 622 may be an X2 interface. The X2 interface may be defined between two or more base stations (e.g., two or more eNBs and the like) that connect to an EPC, and/or between two eNBs connecting to the EPC. In embodiments where the wireless communication system 600 is an NR system (e.g., when CN 624 is a 5GC), the interface 622 may be an Xn interface. The Xn interface is defined between two or more base stations (e.g., two or more gNBs and the like) that connect to 5GC, between a base station 612 (e.g., a gNB) connecting to 5GC and an eNB, and/or between two eNBs connecting to 5GC (e.g., CN 624).

The RAN 606 is shown to be communicatively coupled to the CN 624. The CN 624 may comprise one or more network elements 626, including one or more AMFs, which are configured to offer various data and telecommunications services to customers/subscribers (e.g., users of UE 602 and UE 604) who are connected to the CN 624 via the RAN 606. The components of the CN 624 may be implemented in one physical device or separate physical devices including components to read and execute instructions from a machine-readable or computer-readable medium (e.g., a non-transitory machine-readable storage medium).

In embodiments, the CN 624 may be an EPC, and the RAN 606 may be connected with the CN 624 via an S1 interface 628. In embodiments, the S1 interface 628 may be split into two parts, an S1 user plane (S1-U) interface, which carries traffic data between the base station 612 or base station 614 and a serving gateway (S-GW), and the S1-MME interface, which is a signaling interface between the base station 612 or base station 614 and mobility management entities (MMEs).

In embodiments, the CN 624 may be a 5GC, and the RAN 606 may be connected with the CN 624 via an NG interface 628. In embodiments, the NG interface 628 may be split into two parts, an NG user plane (NG-U) interface, which carries traffic data between the base station 612 or base station 614 and a user plane function (UPF), and the S1 control plane (NG-C) interface, which is a signaling interface between the base station 612 or base station 614 and AMFs.

Generally, an application server 630 may be an element offering applications that use internet protocol (IP) bearer resources with the CN 624 (e.g., packet switched data services). The application server 630 can also be configured to support one or more communication services (e.g., VoIP sessions, group communication sessions, etc.) for the UE 602 and UE 604 via the CN 624. The application server 630 may communicate with the CN 624 through an IP communications interface 632.

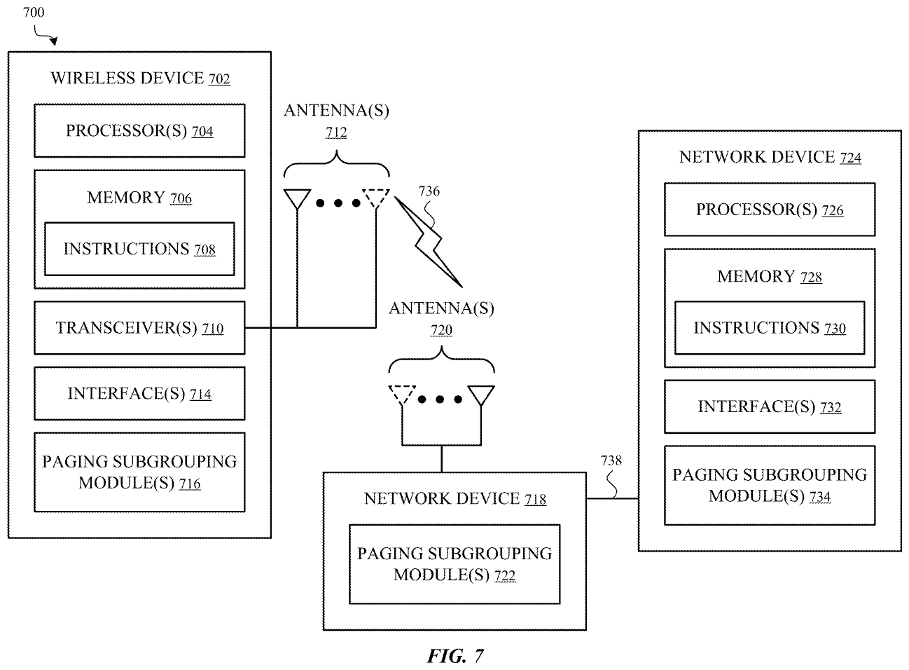

FIG. 7 illustrates a system 700 for performing signaling 736, 738 between a wireless device 702 and network devices 718, 724, according to embodiments disclosed herein. The system 700 may be a portion of a wireless communications system as herein described. The wireless device 702 may be, for example, a UE of a wireless communication system. The network devices 718, 724 may include, for example, a base station (e.g., a gNB) and an AMF of a wireless communication system.

The wireless device 702 may include one or more processor(s) 704. The processor(s) 704 may execute instructions such that various operations of the wireless device 702 are performed, as described herein. The processor(s) 704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 702 may include a memory 706. The memory 706 may be a non-transitory computer-readable storage medium that stores instructions 708 (which may include, for example, the instructions being executed by the processor(s) 704). The instructions 708 may also be referred to as program code or a computer program. The memory 706 may also store data used by, and results computed by, the processor(s) 704.

The wireless device 702 may include one or more transceiver(s) 710 that may include radio frequency (RF) transmitter and/or receiver circuitry that use the antenna(s) 712 of the wireless device 702 to facilitate signaling (e.g., the signaling 736) to and/or from the wireless device 702 with other devices (e.g., the network device 718) according to corresponding RATs.

The wireless device 702 may include one or more antenna(s) 712 (e.g., one, two, four, or more). For embodiments with multiple antenna(s) 712, the wireless device 702 may leverage the spatial diversity of such multiple antenna(s) 712 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 702 may be accomplished according to precoding (or digital beamforming) that is applied at the wireless device 702 that multiplexes the data streams across the antenna(s) 712 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 702 may implement analog beamforming techniques, whereby phases of the signals sent by the antenna(s) 712 are relatively adjusted such that the (joint) transmission of the antenna(s) 712 can be directed (this is sometimes referred to as beam steering).

The wireless device 702 may include one or more interface(s) 714. The interface(s) 714 may be used to provide input to or output from the wireless device 702. For example, a wireless device 702 that is a UE may include interface(s) 714 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 710/antenna(s) 712 already described) that allow for communication between the UE and other devices and may operate according to known protocols (e.g., Wi-Fi®, Bluetooth®, and the like).

The wireless device 702 may include a paging subgrouping module 716. The paging subgrouping module 716 may be implemented via hardware, software, or a combination thereof. For example, the paging subgrouping module 716 may be implemented as a processor, circuit, and/or instructions 708 stored in the memory 706 and executed by the processor(s) 704. In some examples, the paging subgrouping module 716 may be integrated within the processor(s) 704 and/or the transceiver(s) 710. For example, the paging subgrouping module 716 may be implemented by a combination of software components (e.g., executed by a DSP or a general processor) and hardware components (e.g., logic gates and circuitry) within the processor(s) 704 or the transceiver(s) 710.

The paging subgrouping module 716 may be used for various aspects of the present disclosure, for example, aspects of FIG. 1 through FIG. 6. The paging subgrouping module 716 may be configured to, for example, transmit paging subgroup assignment capability information, receive paging subgroup assignment, and monitor for a paging subgroup assigned to a UE for a paging occasion.

The network device 718 may also include one or more processor(s). The processor(s) may execute instructions such that various operations of the network device 718 are performed, as described herein. The processor(s) may include one or more baseband processors implemented using, for example, a CPU, a DSP, an ASIC, a controller, an FPGA device, another hardware device, a firmware device, or any combination thereof configured to perform the operations described herein.

The network device 718 may include a memory. The memory may be a non-transitory computer-readable storage medium that stores instructions (which may include, for example, the instructions being executed by the processor(s)). The instructions may also be referred to as program code or a computer program. The memory may also store data used by, and results computed by, the processor(s).

The network device 718 may include one or more transceiver(s) that may include RF transmitter and/or receiver circuitry that use the antenna(s) 720 of the network device 718 to facilitate signaling (e.g., the signaling 736) to and/or from the network device 718 with other devices (e.g., the wireless device 702) according to corresponding RATs.

The network device 718 may include one or more antenna(s) 720 (e.g., one, two, four, or more). In embodiments having multiple antenna(s) 720, the network device 718 may perform MIMO, digital beamforming, analog beamforming, beam steering, etc., as has been described.

The network device 718 may include one or more interface(s). The interface(s) may be used to provide input to or output from the network device 718. For example, a network device 718 that is a base station may include interface(s) made up of transmitters, receivers, and other circuitry (e.g., other than the transceiver(s)/antenna(s) 720 already described) that enables the base station to communicate with other equipment (e.g., the network device 724) in a core network, and/or that enables the base station to communicate with external networks, computers, databases, and the like for purposes of operations, administration, and maintenance of the base station or other equipment operably connected thereto.

The network device 718 may include a paging subgrouping module 722. The paging subgrouping module 722 may be implemented via hardware, software, or a combination thereof. For example, the paging subgrouping module 722 may be implemented as a processor, circuit, and/or instructions stored in the memory and executed by the processor(s). In some examples, the paging subgrouping module 722 may be integrated within the processor(s) and/or the transceiver(s). For example, the paging subgrouping module 722 may be implemented by a combination of software components (e.g., executed by a DSP or a general processor) and hardware components (e.g., logic gates and circuitry) within the processor(s) or the transceiver(s).

The paging subgrouping module 722 may be used for various aspects of the present disclosure, for example, aspects of FIG. 1 through FIG. 6. The paging subgrouping module 722 may be configured to, for example, transmit UE capability messages, acknowledgements, and other information received from the wireless device 702 to another device (e.g., the network device 724). The paging subgrouping module 722 may also be configured to transmit paging subgroup assignment information received from the network device 724 to the wireless device 702; to receive and locally store paging subgroup assignment information received from the network device 724; and to page the wireless device 702 in accord with the paging subgroup assignment information.

The network device 724 may also include one or more processor(s) 726. The processor(s) 726 may execute instructions 730 such that various operations of the network device 724 are performed, as described herein. The processor(s) 726 may include one or more processors implemented using, for example, a CPU, a DSP, an ASIC, a controller, an FPGA device, another hardware device, a firmware device, or any combination thereof configured to perform the operations described herein.

The network device 724 may include a memory 728. The memory 728 may be a non-transitory computer-readable storage medium that stores instructions 730 (which may include, for example, the instructions being executed by the processor(s) 726). The instructions 730 may also be referred to as program code or a computer program. The memory 728 may also store data used by, and results computed by, the processor(s) 726.

The network device 724 may include one or more interface(s) 732. The interface(s) 732 may be used to provide input to or output from the network device 718. For example, a network device 724 that is an AMF of a core network may include interface(s) made up of transmitters, receivers, and other circuitry that enables the AMF to communicate with other equipment (e.g., the network device 718 via signaling 738, or the wireless device 702 via signaling 738 and the network device 718), and/or that enables the AMF to communicate with external networks, computers, databases, and the like for purposes of operations, administration, and maintenance of the AMF or other equipment operably connected thereto.

The network device 724 may include a paging subgrouping module 734. The paging subgrouping module 734 may be implemented via hardware, software, or a combination thereof. For example, the paging subgrouping module 734 may be implemented as a processor, circuit, and/or instructions 730 stored in the memory 728 and executed by the processor(s) 726. In some examples, the paging subgrouping module 734 may be integrated within the processor(s) 726. For example, the paging subgrouping module 734 may be implemented by a combination of software components (e.g., executed by a DSP or a general processor) and hardware components (e.g., logic gates and circuitry) within the processor(s) 726.

The paging subgrouping module 734 may be used for various aspects of the present disclosure, for example, aspects of FIG. 1 through FIG. 6. The paging subgrouping module 734 may be configured to, for example, receive UE capability messages, acknowledgements, and other information from the wireless device 702. The paging subgrouping module 734 may also be configured to determine paging subgroup assignment information for the wireless device 702, and to transmit paging subgroup assignment information to the wireless device 702 and network device 718.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of wireless communication by a user equipment (UE), comprising:
transmitting a UE capability message, the UE capability message including paging subgroup assignment capability information;
receiving paging subgroup assignment information based at least in part on the UE capability message, the paging subgroup assignment information including an assignment of the UE to a paging subgroup; and
monitoring for a paging occasion associated with the paging subgroup assigned to the UE, in a 5G mobility management (5GMM)_IDLE mode or a 5GMM_CONNECTED mode with radio resource control (RRC)_INACTIVE indication.

2. The method of claim 1, wherein the paging subgroup assignment capability information comprises at least one of:
a first indication of support for paging subgrouping assistance information (PSAI);
a second indication of support for core network (CN)-assigned paging subgrouping (CNSG) allocated by an access and mobility management function (AMF); or
a third indication of support for user equipment identity (UEID)-based paging subgrouping (UEIDSG) based on a temporary identifier for the UE within a next-generation radio access network (NG-RAN).

3. The method of claim 1, further comprising:
transmitting, by the UE and with the UE capability message, paging subgrouping assistance information (PSAI).

4. The method of claim 3, wherein the PSAI comprises paging probability information, the paging probability information identifying a paging probability group within a set of predefined paging probability groups, the paging probability group identifying a group of UEs having a paging probability similar to a paging probability of the UE.

5. The method of claim 3, wherein the PSAI comprises a power profile of the UE, the power profile including at least one of: a type of the UE, an expected battery duration of the UE, or an available power budget of the UE.

6. The method of claim 1, wherein:
the UE capability message is transmitted as part of a REGISTRATION REQUEST message, the REGISTRATION REQUEST message transmitted during an initial registration of the UE to an access and mobility management function (AMF) or during a mobility and periodic registration update (MRU); and
the paging subgroup assignment information is received in a REGISTRATION ACCEPT message.

7. The method of claim 1, further comprising:
receiving a radio access network (RAN) capability message indicating a support for paging subgroup assignments; wherein,
the paging subgroup assignment capability information is included in the UE capability message in response to receiving, in the RAN capability message, an indication of support for paging subgroup assignments.

8. The method of claim 1, wherein, in the 5GMM_IDLE mode or the 5GMM_CONNECTED mode with RRC_INACTIVE indication, the monitored paging occasion occurs comparatively less frequently for the UE, as a member of the paging subgroup, than a second paging occasion occurs for a second UE with no paging subgroup assignment.

9. The method of claim 1, further comprising:
after receiving the paging subgroup assignment information,
receiving, from an access and mobility management function (AMF), a CONFIGURATION UPDATE COMMAND message including the paging subgroup assignment information, the paging subgroup assignment information including the assignment of the UE to the paging subgroup;
configuring the UE, responsive to the CONFIGURATION UPDATE COMMAND message, to monitor the paging occasion; and
transmitting, to the AMF, a CONFIGURATION UPDATE COMPLETE message.

10. The method of claim 1, further comprising:
receiving, from an access and mobility management function (AMF) of a core network (CN), a CONFIGURATION UPDATE COMMAND message including a request for the UE to initiate a registration procedure and re-transmit the UE capability message that includes the paging subgroup assignment capability information.

11. A user equipment (UE), comprising:
a transceiver; and
a processor configured to,
transmit a UE capability message via the transceiver, the UE capability message including paging subgroup assignment capability information;
receive, via the transceiver, paging subgroup assignment information based at least in part on the UE capability message, the paging subgroup assignment information including an assignment of the UE to a paging subgroup; and
monitor for a paging occasion associated with the paging subgroup assigned to the UE, in a 5G mobility management (5GMM)_IDLE mode or a 5GMM_CONNECTED mode with radio resource control (RRC)_INACTIVE indication.

12. The UE of claim 11, wherein the processor is configured to transmit, with the UE capability message, paging subgrouping assistance information (PSAI).

13. The UE of claim 12, wherein the PSAI is transmitted in an information element (IE) having a first set of bits indicating a type of PSAI, and a second set of bits indicating a value for the type of PSAI.

14. A method of communication by a core network (CN), comprising:
receiving, from a user equipment (UE) as part of a REGISTRATION REQUEST message, a UE capability message, the UE capability message including paging subgroup assignment capability information;
assigning the UE to a paging subgroup, based at least in part on the UE capability message;
storing paging subgroup assignment information for the UE in UE context at the CN, the paging subgroup assignment information including the assignment of the UE to the paging subgroup; and
transmitting to the UE, as part of a REGISTRATION ACCEPT message, the paging subgroup assignment information.

15. The method of claim 14, wherein the paging subgroup assignment capability information comprises at least one of:
a first indication of support for paging subgrouping assistance information (PGSA);
a second indication of support for core network (CN)-assigned paging subgrouping (CNSG); or
a third indication of support for user equipment identity (UEID)-based paging subgrouping (UEIDSG).

16. The method of claim 14, further comprising:
receiving, from the UE and with the UE capability message, as part of the REGISTRATION REQUEST message, paging subgrouping assistance information (PSAI); and
transmitting, to a base station in communication with the UE, a UE CONTEXT MODIFICATION REQUEST message including the assignment of the UE to the paging subgroup.

17. The method of claim 16, wherein the PSAI comprises paging probability information, the paging probability information identifying a paging probability group within a set of predefined paging probability groups, the paging probability group identifying a group of UEs having a paging probability similar to a paging probability of the UE.

18. The method of claim 16, wherein the PSAI comprises a power profile of the UE, the power profile including at least one of: a type of the UE, an expected battery duration of the UE, or an available power budget of the UE.

19. The method of claim 14, further comprising:
determining the UE has not acknowledged receipt of the paging subgroup assignment information; and
transmitting to the UE, in response to determining the UE has not acknowledged receipt of the paging subgroup assignment information, new paging subgroup assignment information.

20. The method of claim 14, further comprising:
determining the UE has not acknowledged receipt of the paging subgroup assignment information; and
transmitting to the UE, in response to determining the UE has not acknowledged receipt of the paging subgroup assignment information, a request for the UE to initiate a registration procedure.
